(19) United States
(12) Patent Application Publication
(10) Pub. No.: US 2026/0302696 A1
(43) Pub. Date: Oct. 1, 2026

(54) MAINS-CONNECTION CIRCUIT, MAINS PLUG, IN PARTICULAR SAFETY PLUG, DEVICE FOR SUPPLYING ELECTRICAL ENERGY, AND METHOD FOR CONNECTING A DEVICE FOR GENERATING ELECTRICAL ENERGY TO AN AC MAINS

(71) Applicant: ONSEP CONSULTING UG (HAFTUNGSBESCHRÄNKT), Berlin (DE)

(72) Inventor: Christian Blum, Wabern Zennern (DE)

(21) Appl. No.: 19/490,844

(22) PCT Filed: Jan. 12, 2024
(86) PCT No.: PCT/EP2024/050708

§ 371 Date: Dec. 5, 2025

(30) Foreign Application Priority Data
Jan. 13, 2023 (DE) 10 2023 100 742.4
May 8, 2023 (DE) 10 2023 111 919.2

(51) Int. Cl. H01R 13/713; H01R 24/28; H01R 103/00

(52) U.S. Cl. CPC H01R 13/713; H01R 24/28; H01R 2103/00

(57) ABSTRACT

The invention relates to a network connection circuit for connecting a device for generating electrical energy to an AC voltage network having a protective conductor, a neutral conductor, and an outside conductor, and relates as well to a network plug. In order to recognize correct polarity when connecting the device to the AC voltage network and thus avoid unwanted contacts, the network connection circuit has reverse polarity protection, and the network plug has a displaceable protective device.

The present invention relates to a network connection circuit with reverse polarity protection. The network connection circuit is set up to connect a device for generating electrical energy to an electrical network, e.g., an AC voltage network, which may be a low-voltage network. The device can be a fuel-powered generator or an inverter for a direct current source, such as a solar power system, a battery, or a fuel cell. The network connection circuit has a first and a second connection line. The AC voltage network has a protective conductor, a neutral conductor, and an outside conductor. The first connection line is intended for connection to the neutral conductor, and the second connection line is intended for connection to the outside conductor.

Furthermore, the invention relates to a network plug for realizing an electrical plug contact. The network plug has plug contacts for making a plug connection with a complementarily designed mating connector, e.g., a socket outlet, and a protective contact. The network plug has three connection contacts for connecting conductors of a connection cable to each of the plug contacts.

Furthermore, the invention relates to a device for generating electrical energy, with an energy output having at least three electrical contacts for providing the generated electrical energy.

Furthermore, the invention relates to a method for connecting a device for generating electrical energy to an AC voltage network having a protective conductor, a neutral conductor, and an outside conductor.

Furthermore, the invention relates to network plugs for realizing an electrical plug contact, comprising at least two elongated plug contacts, each having a shaft for electrical contact, a fastening end region, and a free end region.

Devices for generating electrical energy are increasingly being connected to the home network by laypersons in order to make electrical energy generated by a plug-in solar device (e.g., a balcony-based power plant) and converted by the device usable in the home network by electrical consumers. However, it can happen that an outside conductor of the device comes into contact with the neutral conductor of the house network, e.g., because a non-reverse polarity protected plug of the device was inserted into a socket outlet of the house network with the wrong polarity, which may lead to safety problems or technical problems with connected devices. Furthermore, exposed electrical contacts carrying a voltage can endanger laypersons.

The object of the invention is therefore that of making the use of devices for generating electrical energy safer.

This object is achieved for the aforementioned network connection circuit in that it has a phase position recognition device. The phase position recognition device is electrically connected to the first and second connection lines and is designed to determine a phase position between the second connection line and the first connection line. The phase position can be, in particular, the position relative to the network-side phase. The phase position recognition device is designed to provide an operating signal when the phase position corresponds to a predetermined phase position, and to output an error signal when the phase position deviates from the predetermined phase position.

For the network plug mentioned at the outset, the object is achieved by connecting the plug contacts and the protective contact to the connection contacts with a reverse polarity protective circuit according to the invention.

Furthermore, the object for the aforementioned device for generating electrical energy is achieved by placing a reverse polarity protective circuit according to the invention upstream of the energy output and, for example, galvanically connecting it to the energy output.

Furthermore, the object for the method mentioned at the outset is achieved by the fact that, after mechanically contact of an energy output of the device with the electrical network, such as an AC voltage network, using a network plug, the polarity of the energy lines of the device leading to the energy output is first compared with the polarity of the lines of the AC voltage network, and the device is connected to the AC voltage network depending upon the result of the comparison.

Furthermore, the object for the network plug mentioned at the outset is achieved by the fact that the network plug includes at least one protective device with which at least the shafts of the plug contacts are protected or can be protected against unintentional electrical contact, wherein a relative movement is possible between at least one region of the protective device and the plug contacts, so that the shafts of the plug contacts can at least partially be exposed and electrically contacted.

Only by recognizing the correct or incorrect phase position and subsequently providing the operating and fault signals representing the correct or incorrect phase position is it possible to connect the device electrically and safely to the low-voltage network after the mechanical coupling. According to the invention, among other things, a touch protection device is provided which releases the plug contacts for electrical contact only after the plugging process has been completed, as well as a downstream method for protective circuitry (reverse polarity protection and/or electrical protective switches such as RCD's or AFDD's). Protection against contact is also provided by the network plug, which mechanically secures the plug contacts against contact.

According to an advantageous embodiment of the network connection circuit, the network connection circuit has a switching element which, in the closed state, connects two portions of the second connection line when the phase position recognition device provides the operating signal.

One advantage of this embodiment can be that the electrical connection is established automatically, but only with the correct polarity, provided the phase position is correct.

According to an advantageous embodiment of the network connection circuit, the network connection circuit has a switching element configured to connect two portions of the first connection line together and to connect two portions of the second connection line together when the phase position recognition device provides the operating signal, and configured to connect a portion of the first connection line to a portion of the second connection line, and to connect another portion of the first connection line to another portion of the second connection line when the phase position recognition device does not provide the operating signal.

One advantage of this embodiment can be that the electrical connection is established automatically with the correct polarity.

According to an advantageous embodiment of the method, a connection between a, when operating the device, outside conductor and an outside conductor of the AC voltage network is made only if the comparison shows that the power lines are connected with the same polarity to the lines of the AC voltage network via the network plug.

One advantage of this embodiment can be that the electrical connection is established automatically, but only with the correct polarity, provided the phase position is correct.

According to an advantageous embodiment of the method, a connection between a, when operating the device, outside conductor and an outside conductor of the AC voltage network is first switched crosswise and then closed if the comparison shows that the power lines are connected with non-uniform polarity to the lines of the AC voltage network via the network plug.

One advantage of this embodiment can be that the electrical connection is established automatically with the correct polarity.

The network plug can be a protective contact plug, a two-pole network plug, a three-pole network plug, or a three-phase plug. Three-phase current is a multi-phase alternating current. If the plug has multiple contacts for connection to outside conductors, the network connection circuit can be designed to control the phase position for a plurality or all of these contacts and optionally to close or keep open switching elements for a plurality or all of these contacts depending upon the phase positions. If the plug has multiple contacts for connection to outside conductors, the network connection circuit may be designed to switch the phase position to the correct phase position for a majority or for all of these contacts.

The disclosures relating to protective conductors may refer by way of example to plug type F (CEE 7/4), wherein an application to other CEE plug types, e.g., CEE system with CEE 7/4 alias Schuko plug, CEE 7/5 France, and CEE 7/7 German/French hybrid plug, or CEE 7/15 Europlug, may also be included. Other plug types that are used worldwide (e.g., NEMA plugs) can also be used with the present invention.

The electrical phase position relative to the protective conductor can be determined before the energy supply device is switched on. An electronic or electrical circuit, such as the phase position recognition device, can process the phase position. The decision as to whether the phase position is correct can be made purely logically as true or false. Depending upon the decision, operating or error signals can be output. Depending upon the decision and/or the operating or fault signal, the circuit can be blocked or the phase position corrected.

Furthermore, unintentional exposure, i.e., energizing of the contacts by the device outside the designated insertion device, can be prevented. The invention can also provide protection against reversing the connection conditions and corresponding signaling.

The present disclosure further relates to a network plug, in particular a protective contact plug, as well as aspects relating to a system and a method for providing electrical energy. The network plug, system, and/or method disclosed below may be advantageous independently of the invention disclosed thusfar.

Due to the need to reduce environmentally harmful emissions and decrease energy costs, decentralized energy sources in the form of energy converters are increasingly required.

Especially for individual households or smaller consumers, these can also be systems with a relatively low power range. Such systems should be inexpensive and flexible to set up and operate.

This also requires a simple, user-friendly, and safe electrical connection option for the system to the AC voltage network—for example, a low-voltage network.

To reduce costs, it is also desirable that the components used be largely standardized components.

Furthermore, it is necessary to feed generated electrical energy into an existing network in a simple and cost-effective manner or to make it available to a consumer.

Energy transmission means must be provided for this.

There are various energy transmission means in the form of plugs and complementary socket outlets.

For example, EP 3 309 917 A1 discloses a device with a touch-protected arrangement of electrical connection elements, in which it is impossible for a user to touch a live component of one of several connection elements, wherein the device has a housing divided into several compartments and open on at least one side, several electrical connection elements arranged in each of the compartments, and a sliding cover for all compartments from the second compartment onwards, wherein the at least one, preferably several, sliding covers are slidably fixed to the housing in such a way that, if one of the compartments or connection elements is accessible, all other compartments or connection elements are covered by a sliding cover.

DE 2 112 899 A1 discloses an electrical contactor with plugs having an ejector comprising a body made of electrically insulating material, which is provided with at least one pair of contact pins or plug elements. Furthermore, at least one ejector lever with two arms is provided, which are arranged at an intermediate point of a fixed or fixedly connected part of the body of the plug contact itself, wherein one arm of the lever can act against a contact surface, and the other arm of the lever can be operated by hand to rotate the lever about its pivot axis in order to eject it or push out the plug contact of a socket outlet.

The improvement upon the known aspects is based upon the object of providing a plug, such as a protective contact plug, as well as a system and a method for providing electrical energy, which enable the transmission of electrical energy in a simple, safe, and customer-friendly manner. This improvement can be advantageous regardless of whether a complementary mating connector, such as a socket outlet, is designed to work with the plug.

Furthermore, the following is disclosed:
A) A network plug for realizing an electrical plug contact, comprising at least two elongated plug contacts, each having a shaft for electrical contact, a fastening end region, and a free end region, and comprising at least one protective device with which at least the shafts of the plug contacts are protected or can be protected against unintentional electrical contact, wherein a relative movement is possible between at least one region of the protective device and the plug contacts, so that the shafts of the plug contacts can at least partially be exposed and electrically contacted.
B) Network plugs according to aspect A), wherein the shafts of the plug contacts may be covered or coverable in an electrically insulating manner by means of a protective element of the protective device.
C) Network plugs according to one of aspects A) and B), wherein the protective device for covering the shafts of the plug contacts may comprise a spring-mounted protective sleeve device, which has a protective sleeve designed at least partially in a hollow-cylindrical form for each plug contact as a protective element, wherein the protective sleeve device may further have a base element, and the protective sleeves may be rigidly mechanically coupled to each other by means of the base element, so that they are together displaceable on the shafts of the plug contacts.
D) Network plug according to one of aspects A) and B), wherein the protective device may have compressible protective bodies as protective elements for covering the shafts of the plug contacts along the longitudinal direction of the plug contacts, which bodies are rigidly mechanically coupled to one another by means of a base element, wherein an end region of each protective body may be displaceable by compressing the protective body in order to expose the shaft of the plug contact. This thus makes it possible to prevent the touch protection from being unintentionally exposed on one side. Only a defined, two-sided retraction is possible. One advantage of the compressible protective body can be that the volume into which the protective device for exposing the plug contacts can be inserted can be designed to be shorter than when using non-compressible protective bodies.
E) Network plug according to one of aspects C) and D), wherein the network plug may have a guide device for guiding the protective device along the longitudinal direction of the plug contacts, wherein the guide device may counteract uneven displacement of the protective elements on the plug contacts by canting the base element on a guide element of the guide device.
F) Network plugs according to aspect E), wherein, when the protective elements are designed as at least partially hollow-cylindrical protective sleeves, the guide device may be arranged between the plug contacts; and that, when the protective elements are designed as compressible protective bodies, the guide device in the base element of the network plug may have guide elements which may be arranged on that side of a plug contact facing away from the respective other plug contact.
G) Network plug according to aspect A), wherein the network plug may have a housing as a protective device, wherein a relative movement may be possible between the housing and the plug contacts, so that the plug contacts can be moved into the housing and out of the housing.
H) Network plug according to aspect G), wherein the network plug may have a drive element with which, when a manual actuating force is applied, a movement of the plug contacts out of the housing can be effected, in particular if this is located in or on the complementary mating socket outlet.
I) Network plug according to one of aspects G) and H), wherein the network plug may have a blocking device with at least one movable actuating element to prevent relative movement between the housing and the plug contacts, which, when the network plug is inserted into a socket outlet, is movable by a protective contact of the socket outlet and can thus remove a blockage of relative movement between the housing and the plug contacts.
J) Network plug according to one of the preceding aspects, wherein the network plug may have a protective circuit. The protective circuit can be the network connection circuit mentioned at the outset. The protective circuit can have a first switching element, such as a first relay, and a second switching element, such as a second relay. When the first switching element is energized, it can close a current path to the second switching element via a first switch, such as a first relay switch, so that the latter is energized, and thereby the second switching element opens the current path to the first switching element via a second switch, such as a second relay switch, thus closing a circuit. The protective circuit can be part of the network connection circuit or correspond to it. The protective circuit can be the phase position recognition device or can have one.

Furthermore, an arc fault detection device (AFDD, AFCI) and/or a residual current circuit breaker (RCCB, RCD) may be provided. The arc fault protection device and/or the residual current circuit breaker can be provided separately or as part of the protective circuit and/or the network connection circuit and/or the plug and/or the device.

The electrical phase position relative to the protective conductor can be determined before the energy supply device is switched on. An electronic or electrical circuit, such as the phase position recognition device, can process the phase position. The decision as to whether the phase position is correct can be made purely logically as true or false. Depending upon the decision, operating or error signals can be output. Depending upon the decision and/or the operating or fault signal, the circuit can be blocked or the phase position corrected.

Furthermore, unintentional exposure, i.e., energizing the contacts by the device outside the designated insertion device, can be prevented. The invention can also provide protection against reversing the connection conditions and corresponding signaling.

The switching elements and their interconnection disclosed in aspect J) can form the phase position recognition device, into which the switching element mentioned above is integrated.
K) Network plug according to aspect J, wherein a first contact of the second switch and a first signaling device may be arranged in a first current path between a live phase of the network plug and a neutral conductor of the network plug connected in series.
L) Network plug according to one of aspects J) and K), wherein a second contact of the second switch and a second signaling device may be arranged in a second current path between the live phase and the neutral conductor connected in series.
M) Network plug according to one of aspects J) to L), wherein the first switching element may be arranged in a third current path between the live phase and that protective conductor of the network plug designed as a protective contact plug.
N) System for providing electrical energy, comprising a device for generating electrical energy and a network plug according to one of aspects A) to M), wherein the plug contacts of the network plug are electrically conductively connected to phases of the device for generating electrical energy or can be connected by means of a switching device.
O) Method for providing electrical energy in which a system for providing electrical energy in accordance with aspect N) is provided, electrical energy is generated by means of the device for generating electrical energy, and the electrical energy is fed into a power network or supplied to an electrical consumer by means of the network plug.

In other words, one aspect of the present disclosure is a network plug for realizing an electrical plug contact, comprising at least two elongated plug contacts, each having a shaft for electrical contact, a fastening end region, and a free end region, and comprising at least one protective device with which at least the shafts of the plug contacts are protected or can be protected against unintentional electrical contact. Relative movement is possible between at least one region of the protective device and the plug contacts, so that the shafts of the plug contacts can at least partially be exposed and electrically contacted.

The network plug is designed to realize an electrical plug contact in a socket outlet. The socket outlet can be a network socket outlet for connection to the public or a private power network. The plug contacts serve this purpose, for insertion or arrangement into complementarily designed socket receptacles of the socket outlet. The pin head or free end region can be made of insulating material to avoid frontal electrical contact.

One embodiment provides that the shafts of the plug contacts be covered or be able to be covered in an electrically insulating manner by means of a protective element of the protective device.

The protective device for covering the shafts of the plug contacts can comprise a spring-mounted protective sleeve device, which has a protective sleeve that is at least partially hollow-cylindrical for each plug contact, wherein the protective sleeve device further has a base element, and the protective sleeves are rigidly mechanically coupled to each other by means of the base element, so that they are together displaceable on the shafts of the plug contacts. Each protective sleeve can be designed substantially in a hollow-cylindrical shape. The respective protective sleeve is substantially non-compressible along the longitudinal direction of the plug contacts.

An alternative embodiment provides that the protective device have compressible protective bodies as protective elements for covering the shafts of the plug contacts along the longitudinal direction of the plug contacts, which bodies are rigidly mechanically coupled to one another by means of a base element, wherein an end region of each protective body is displaceable by compressing the protective body in order to expose the shaft of the plug contact. To expose the shafts, it is provided here that only one end region of the respective protective body be moved, while the opposite end region of the protective body remains supported on a base element. Each protective body has a through-opening in which the respective plug contact is located.

Each compressible protective body can be elastically compressible, so that it can form an elastic restoring force in the compressed state. Such a protective body may, for example, be a foam body. If necessary, a single foam body can form both protective elements. This means that the foam body can be implemented as a single membrane/foam body or as two, separate cylinder membrane/foam bodies.

The network plug can have a guide device for guiding the protective device along the longitudinal direction of the plug contacts, wherein the guide device can counteract uneven displacement of the protective elements on the plug contacts by canting the base element on a guide element of the guide device. Uneven movement would occur if one protective element moves further in a unit of time than the other protective element.

The base element can have a canting element. The housing of the network plug may have a counter-canting element. The canting element can be designed to be complementary to the counter-canting element. For example, the canting element is a recess in the base element or a groove that extends completely through the base element in the insertion direction of the plug. The canting element can have an open end that points transversely to the insertion direction. The canting element can be located at an edge of the base element. The edge can circumferentially surround the base element transversely to the insertion direction, thus extending around the base element in a circumferential direction pointing around the insertion direction. The insertion direction can be a direction in which the network plug can be inserted into a mating connector and/or correspond to the longitudinal direction of the protective sleeve and/or the plug contacts. The mating connector can be a coupling, or a receptacle, or a socket outlet.

The counter-canting element can be designed as a rib or as a projection that engages in the groove or the recess. The counter-canting element can extend along the insertion direction and have a free end pointing transversely to the insertion direction—for example, into the interior of the plug. The entire counter-canting element can run parallel to the insertion direction.

A clear width of the canting element and a width of the counter-canting element parallel to the clear width can be dimensioned such that the base element with the canting element can slide on the counter-canting element when the base element is pushed further into the plug housing along the insertion direction. For example, the clear width and the width are the same.

If the base element is pushed further into the plug housing along the insertion direction, the canting element can slide on the counter-canting element. However, if a force acts upon the base element, wherein the force acts at an angle to the insertion direction that is not equal to 0° or not equal to 180°, this force can tilt the base element. This tilting action allows the canting element and the counter-canting element to cant with each other, so that the force does not cause any further movement of the base element along the insertion direction into the plug housing, and the plug contacts remain in the protective device and cannot protrude from it in a non-contactable manner.

The canting leads to a self-locking effect if one of the protective sleeves is pushed further than the other. In this case, the guide element no longer runs transversely to the base element, so that the base element exerts two opposing forces on the guide element, spaced apart in their lines of action, the magnitude of which forces increases with increasing angle of the guide element, starting from a right-angled position of the base element in relation to the guide path.

Even before the front part of the protective sleeves reaches the insulated region of the contact pin tips, the internal guide element (protective sleeve carrier plate, base element—hereafter designated by 42) can be moved radially onto the spring guide, and further forward movement can be prevented. An additional ripple or blockage cant protection can provide a subsequent second or additional level of protection (back-up protection).

These forces acting transversely upon the guide element cause corresponding frictional forces on the guide element, which lead to self-locking of the movement of the protective sleeve device.

If the protective elements are designed as at least partially hollow-cylindrical protective sleeves, the guide device can be arranged between the plug contacts. When the protective elements are designed as compressible protective bodies, the guide device in the base element of the protective contact plug can have guide elements that are arranged on that side of a plug contact facing away from the respective other plug contact.

An alternative arrangement when the protective elements are designed as at least partially hollow-cylindrical protective sleeves consists in the guide device being formed by the plug contacts themselves, which in this embodiment accordingly form the guide elements.

As an alternative to designing the protective elements as hollow cylinders, at least one of the protective elements can have a receiving volume for one of the plug contacts, the diameter of which runs transversely to the insertion direction and can decrease toward the free ends of the protective elements. The receiving volume can, for example, be shaped like a cone. A minimum diameter of the receiving volume can substantially correspond to the outer diameter of one of the plug contacts. Tilting the protective device can also cause at least one of the protective elements to jam against one of the plug contacts, resulting in self-locking.

The inner diameter of at least one of the protective elements can be minimal at its free end and substantially correspond to the outer diameter of one of the plug contacts. This can prevent small or thin conductors, such as a wire, from simply being inserted into one of the protective elements at the insulated end of one of the plug contacts. This allows for a corresponding level of protection, e.g., IP2x or the like, to be achieved.

In the alternative embodiment with compressible protective bodies, the guide elements on that side of the compressible protective bodies facing away from the base element can be rigidly connected to each other by means of a pressure plate.

When the network plug is inserted into a socket outlet, a corresponding force can be applied to this pressure plate by the socket outlet, which leads to a displacement of the end regions of the compressible protective bodies on the plug contacts and thus to an exposure of a part of the respective shaft of a plug contact.

The pressure plate or the end regions of the compressible protective bodies are guided by means of the guide device.

The compressible protective elements can be made of foam. Furthermore, the materials used for the protective elements may have water-repellent material properties, flame retardancy, possibly halogen-free, class B1/B2, and a density in the range of RG>15 kg/m3, and/or a compression hardness in the range of SH<20 g/cm2.

Another embodiment of the network plug provides that the network plug have a housing as a protective device, wherein a relative movement is possible between the housing and the plug contacts, so that the plug contacts can be moved into and out of the housing. This allows the plug contacts to be, at least in portions or regions, exposed and electrically connected when removed from the housing. Once they have been moved into the housing, the plug contacts are protected against unintentional electrical contact. The casing can be made of flame-resistant material.

In this embodiment, the network plug can have a drive element with which, when a manual actuating force is applied, a movement of the plug contacts out of the housing can be effected. The drive element can be mechanically fixed to the plug contacts and protrude from the housing, so that a manual force on the drive element causes a displacement of the plug contacts, so that at least their free end regions and, in some regions, the shafts of the plug contacts protrude from the housing and can be inserted into socket receptacles of a socket outlet.

Furthermore, to prevent relative movement between the housing and the plug contacts, the network plug may have a blocking device with at least one movable actuating element which, when the network plug is inserted into a socket outlet, can be moved by an optional protective contact of the socket outlet and thus can remove a blockage of relative movement between the housing and the plug contacts. This means that the network plug can be designed in such a way that—as long as the network plug is not inserted into a socket outlet—relative movement between the housing and the plug contacts is prevented by means of the blocking device, so that no movement of the plug contacts can occur out of the housing, and accordingly no unintentional electrical contact of the plug contacts can occur.

In this situation, the plug contacts are accommodated in an electrically protected manner in the housing. When the operating element is moved by the protective contact of the socket outlet, e.g., by pressing it in, the blocking effect is lifted, and the plug contacts can be moved out of the housing and thus into socket receptacles of the socket outlet.

Furthermore, the network plug may have a spring assembly which, when the spring assembly is tensioned, indirectly or directly exerts a spring force on the plug contacts and/or on the housing, so that the plug contacts are automatically moved into the housing, unless they are fixed by socket receptacles of a mating connector—for example, a socket outlet or a coupling. Alternatively or additionally, the network plug may have a protruding protective contact pin (e.g., CEE 7/5) which, when inserted, releases the electrical connection of the plug contacts with the device.

Depending upon the strength of the spring assembly and the assumed fixing forces acting upon the plug contacts from the socket receptacles of the socket outlet, the network plug may have a fixing device with which the plug contacts can be fixed in a position moved out of the housing. This prevents the plug contacts, when plugged into the socket outlet and under potentially low clamping forces of the socket receptacles of the socket outlet, from automatically retracting into the housing and consequently extending out of the socket receptacles due to the spring force of the spring assembly.

The base element can have at least one receiving opening and, for example, two receiving openings for receiving the spring guide. The at least one receiving opening can extend completely through the base element in the insertion direction. The at least one receiving opening can be completely surrounded by the material of the base element transversely to the insertion direction. The at least one receiving opening can be arranged between the protective elements. If several, e.g., two, receiving openings are provided, these can be arranged one behind the other in a direction transverse to the insertion direction and in which the protective elements are spaced apart from each other.

The spring guide of the plug can be designed as a pin extending in the insertion direction, onto which the spring assembly, e.g., a coil spring, can be plugged. In this case, it may be sufficient if the base element has only one receiving opening. The diameter of the receiving opening can be smaller than the diameter of the spring assembly, so that the material of the base element, which at least partially surrounds the receiving opening, can serve as a support or stop for the spring assembly. The diameter of the receiving opening can substantially correspond to the diameter of the pin, so that the base element with the receiving opening can slide and cant on the pin.

The spring guide of the plug can have at least two guide beams running parallel to the insertion direction, the sides of which facing each other can be substantially complementary to the spring assembly—for example, a coil spring. The guide beams can be arranged opposite each other and/or spaced apart from each other, transversely to the insertion direction.

The base element can have one of the receiving openings for each of the guide beams. At least one of the receiving openings can be designed to be complementary to the guide beam it receives, so that the base element with the receiving opening can slide and cant on the guide beam.

The base element may have a support bridge remaining between the receiving openings and which may rest against the spring assembly. The support bridge can have a larger contact area with the spring assembly than the material of the base element that at least partially surrounds the receiving opening.

All described embodiments may have in common that they feature an arc fault protection device, which is also referred to as an arc fault circuit interrupter (AFCI). Such an arc fault protection device can, for example, be an AFDD (“Arc Fault Detection Device”) or an AFCI (“Arc Fault Circuit Interrupter”). Alternatively, the network plug can be designed to be electrically or galvanically connected to an arc fault protection device and/or a residual current circuit breaker.

Furthermore, the network plug can be a protective contact plug.

Furthermore, each of the described embodiments can have a protective circuit with a first switching element, e.g., a relay or a semiconductor switch such as a triac, and a second switching element, e.g., a relay or a semiconductor switch such as a triac, wherein, when the first switching element is energized—if a correct circuit exists—this first switching element closes a current path to the second switching element via a first switch, so that the latter is energized, and thereby the second switching element opens the current path to the first switching element via a second switch, thereby closing a circuit. The protective circuit can be part of the network connection circuit or correspond to it. The protective circuit can be the phase position recognition device or can have one.

Accordingly, if the plug contacts of the network plug are connected in a socket outlet in the correct phase, a current flows from a live phase to the first switching element. This is activated by closing a current path to the second switching element. The second switching element also switches, thus in turn de-energizing the first switching element, but thereby closing a current path to an external contact, such as a socket outlet. In this way, an electric current can flow from the network plug to a socket outlet via the plug contacts.

If there is no phase-correct contact between the plug contacts of the network plug in a socket outlet, there is also no current flow from a live phase to the first switching element. This is therefore not activated, so it does not close a current path to the second switching element.

The second switching element also does not switch, so it does not close a current path to an external contact, such as a socket outlet.

If the network plug is inserted the wrong way around, the circuit will not be closed. This ensures reverse polarity protection.

In a first current path between a live phase of the network plug and a neutral conductor of the network plug, a first contact of the second switching element and a first signaling device can be arranged in series. The first signaling device can be a light element, such as a red lamp. Accordingly, if no proper contact exists, a signal is output via the first signaling device, indicating that no proper contact has been established. Appropriate electrical dimensioning can ensure that no upstream protective devices (e.g., residual current circuit breakers) trip.

In a second current path between the live phase and the neutral conductor, a second contact of the second switching element and a second signaling device can be arranged in series. The second signaling device can be a green light. If correct contact is established, the second signaling device will output a corresponding signal. Reverse polarity protection can also be implemented without a signal device in the correct contact direction.

In addition, a hand switch can be arranged in series with the second signaling device, which hand switch is designed, for example, as a normally closed switch, so that the signal output via the second signaling device occurs only when the hand switch has been closed.

The first switching element can be arranged in a third current path between the live phase and a reference potential conductor or protective conductor. The reference potential conductor or protective conductor is the reference point for the alternating voltage. If the network plug has a protective conductor, the network plug can be a protective contact plug. The reference potential conductor or protective conductor is galvanically isolated from the outside conductor(s) during the regular operation of the network connection circuit, i.e., when the plug is inserted with the correct polarity, or the reverse polarity protective circuit has switched the polarity. The galvanic isolation is achieved through the switches—for example, relays.

The described network plug can also be designed with plug contacts on its side opposite the plug contacts and therefore as an adapter.

When the network plug is not inserted into a socket outlet, the described design features ensure protection against electric shock. This allows for user-friendly use of the network plug at a power source.

When the network plug is inserted into a socket outlet, electrical energy can be supplied to a network or a consumer via the network plug. The integrated reverse polarity protection ensures that a correct phase connection is achieved. If the network plug is connected to the wrong phase of the power network, it interrupts the flow of electricity. This enables safe operation with respect to electrical network feedback from connected devices or energy sources, especially energy sources with converters.

Another aspect of the present invention is a system for providing electrical energy, which comprises a device for generating electrical energy and a described network plug, wherein the plug contacts of the network plug are electrically conductively connected to phases of the device for generating electrical energy or can be connected by means of a switching device.

The present invention further comprises a method for providing electrical energy, in which a system for providing electrical energy is provided, electrical energy is generated by means of the device for generating electrical energy, and the electrical energy is fed into a power network or supplied to an electrical consumer by means of the network plug. When electrical energy is supplied to an electrical consumer, the generated electrical energy is thus used directly. The invention will be explained below with reference to the exemplary embodiments shown in the accompanying drawings.

The following are shown:

FIG. 1: a network plug with housing of a first embodiment in a side view,

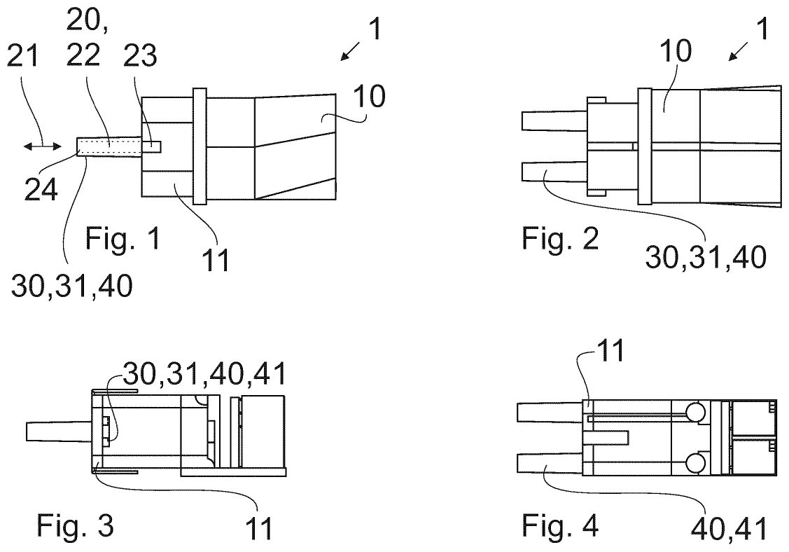

FIG. 2: the network plug with housing of the first embodiment in a top view,

FIG. 3: the network plug without housing of the first embodiment in a side view,

FIG. 4: the network plug without housing of the first embodiment in a top view,

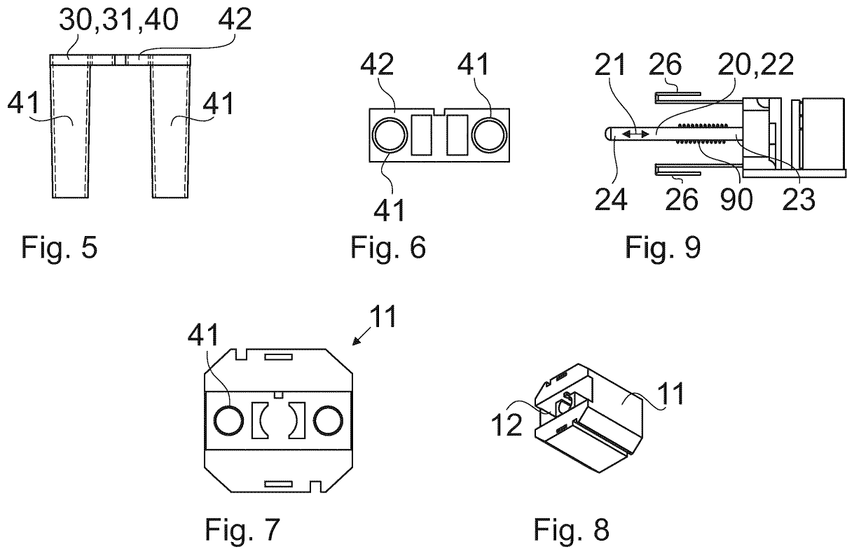

FIG. 5: a protective sleeve device for the network plug of the first embodiment in a side view,

FIG. 6: the protective sleeve device in a frontal view,

FIG. 7: a main body for the network plug of the first embodiment with protective sleeve device included therein in a frontal view,

FIG. 8: the main body for the network plug of the first embodiment in a perspectival view,

FIG. 9: the network plug without housing of the first embodiment in a side view,

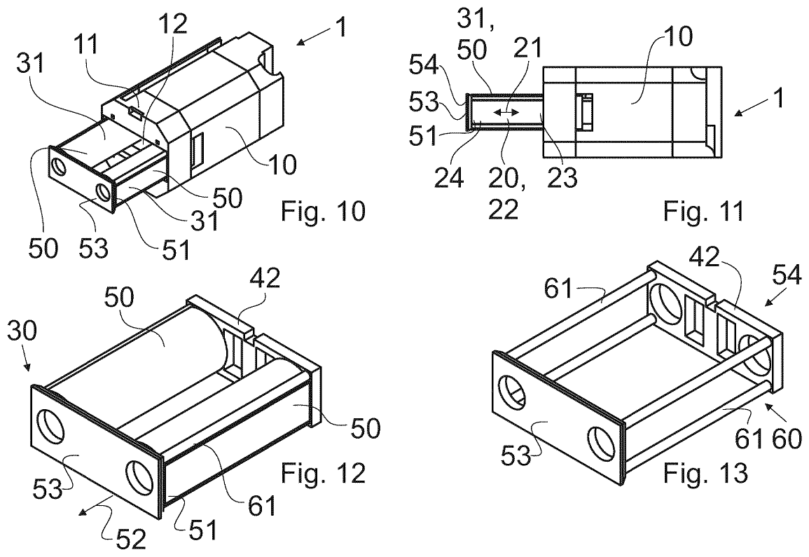

FIG. 10: a network plug with housing of a second embodiment in a perspectival view,

FIG. 11: the network plug without housing of the second embodiment in a side view,

FIG. 12: a protective device with protective bodies for the network plug of the second embodiment in a perspectival view,

FIG. 13: the protective device without a protective body for the network plug of the second embodiment in a perspectival view,

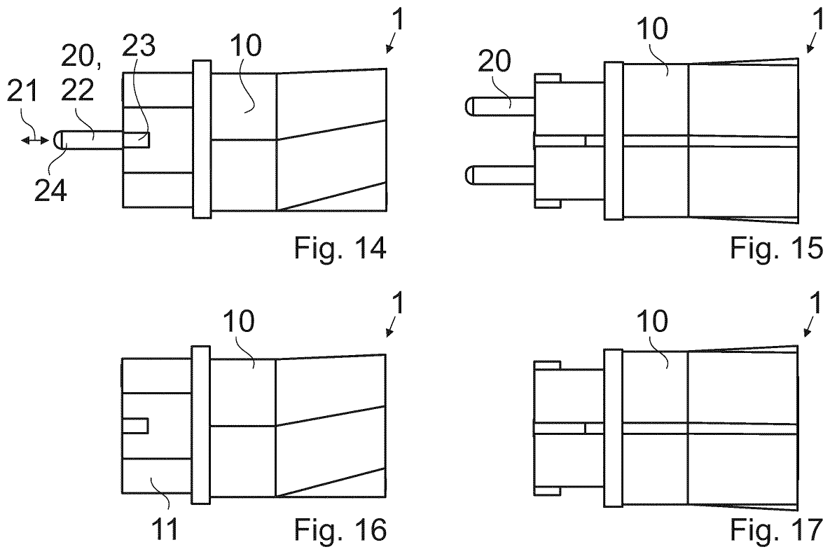

FIG. 14: a network plug with housing of a third embodiment with extended plug contacts in a side view,

FIG. 15: the network plug with housing of the third embodiment with extended plug contacts in a top view,

FIG. 16: the network plug with housing of the third embodiment with retracted plug contacts in a side view,

FIG. 17: the network plug with housing of the third embodiment with retracted plug contacts in a top view,

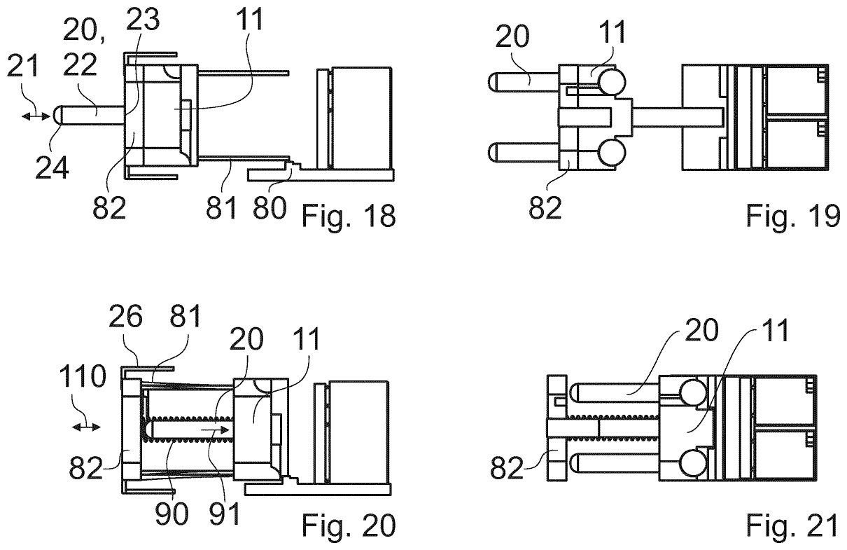

FIG. 18: the network plug without housing of the third embodiment with extended plug contacts in a side view,

FIG. 19: the network plug without housing of the third embodiment with extended plug contacts in a top view,

FIG. 20: the network plug without housing of the third embodiment with retracted plug contacts in a side view,

FIG. 21: the network plug without housing of the third embodiment with retracted plug contacts in a top view,

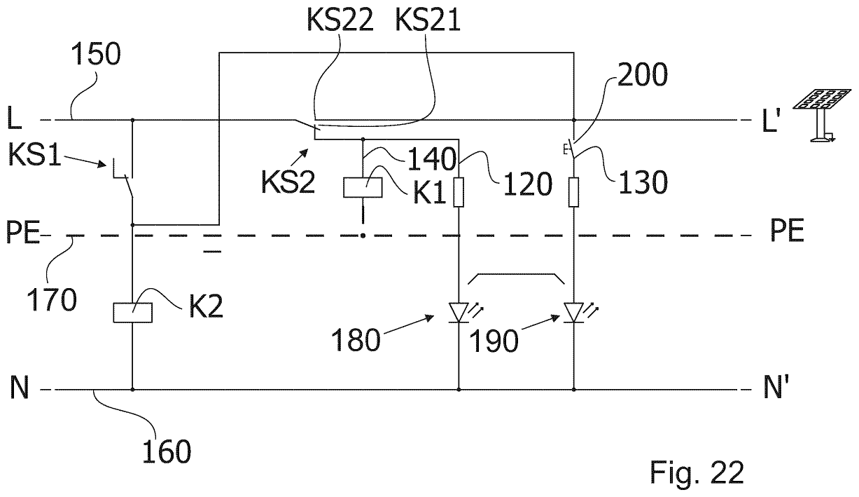

FIG. 22: a first exemplary embodiment of the network connection circuit,

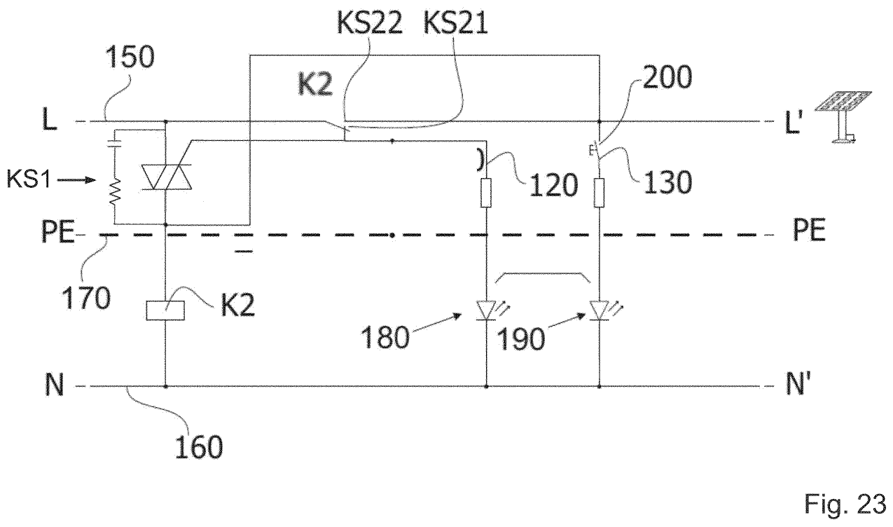

FIG. 23: a second exemplary embodiment of the network connection circuit,

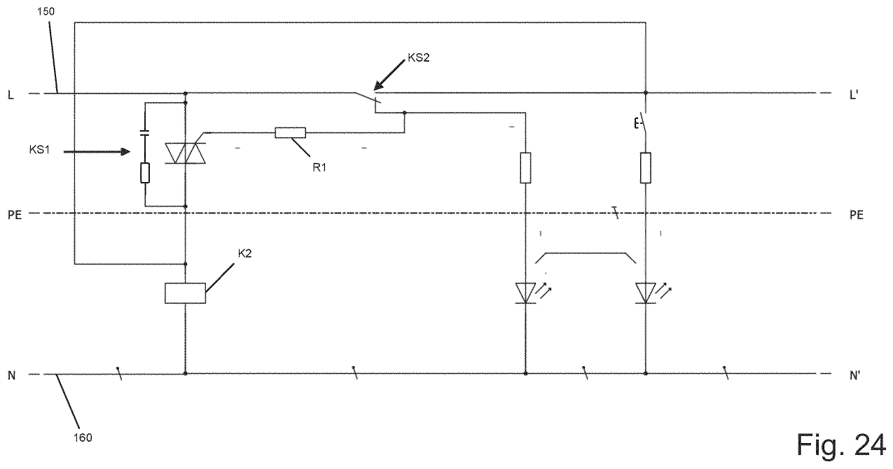

FIG. 24: a third exemplary embodiment of the network connection circuit,

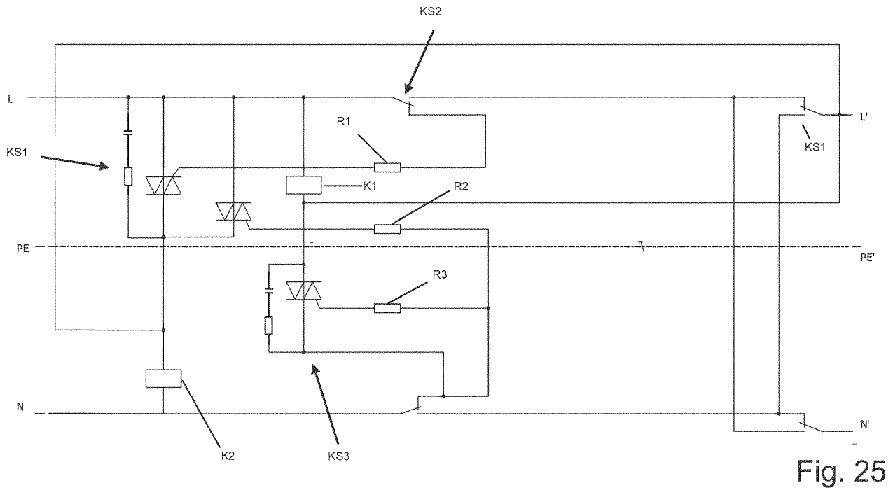

FIG. 25: a fourth exemplary embodiment of the network connection circuit,

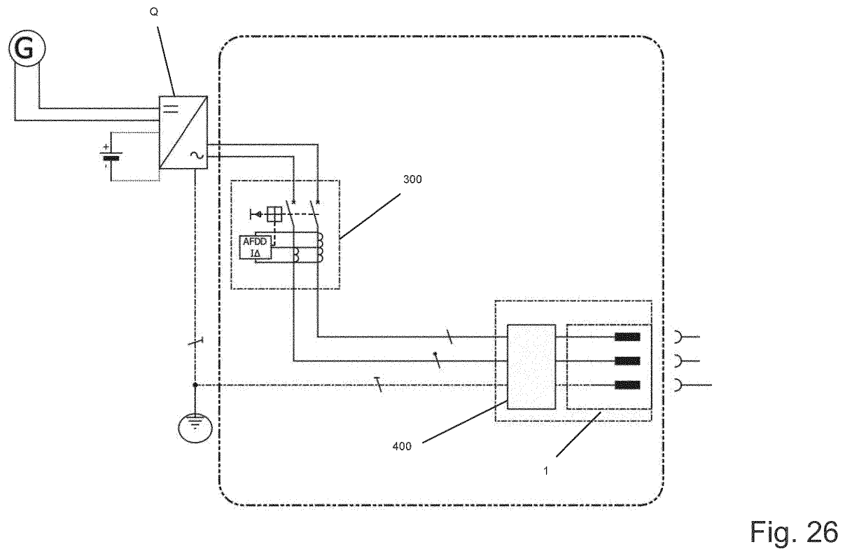

FIG. 26: a first exemplary embodiment of a network connection device,

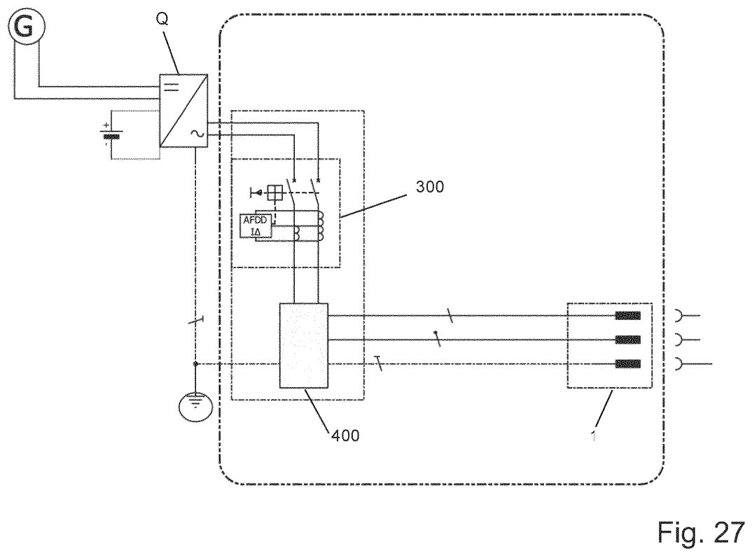

FIG. 27: a second exemplary embodiment of a network connection device,

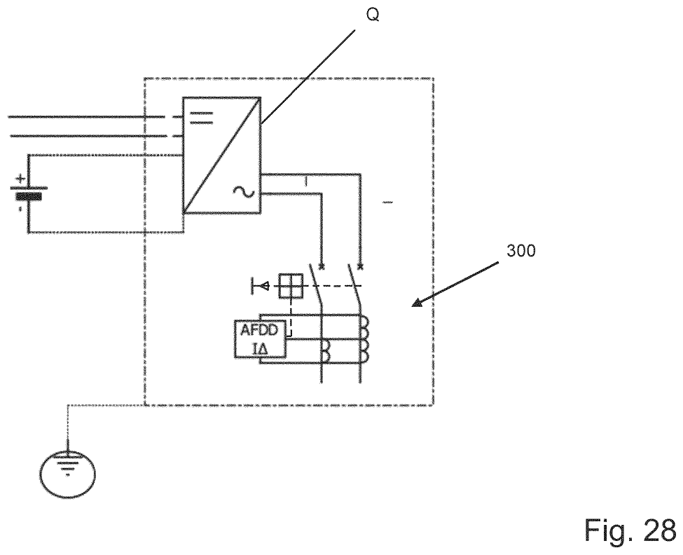

FIG. 28: an exemplary embodiment of a network connection module,

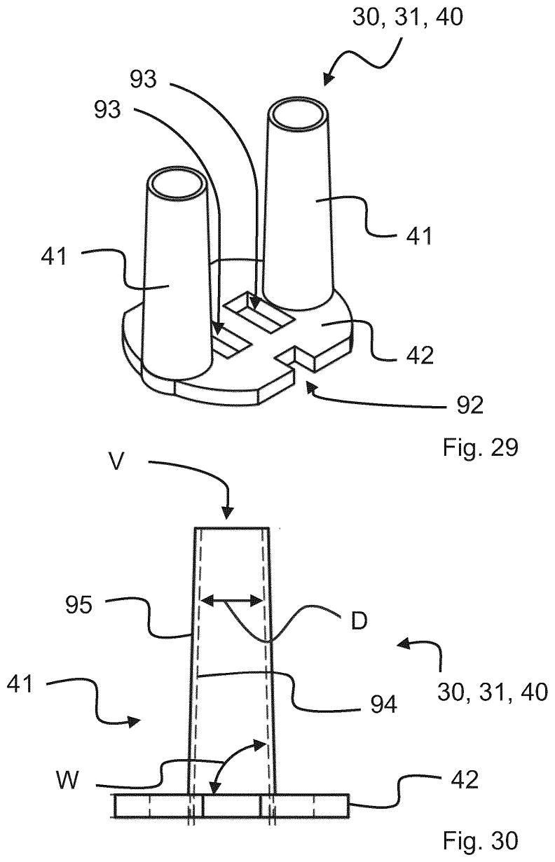

FIG. 29: a further exemplary embodiment of a protective sleeve device in a perspectival view,

FIG. 30: the exemplary embodiment of FIG. 29 in a side view,

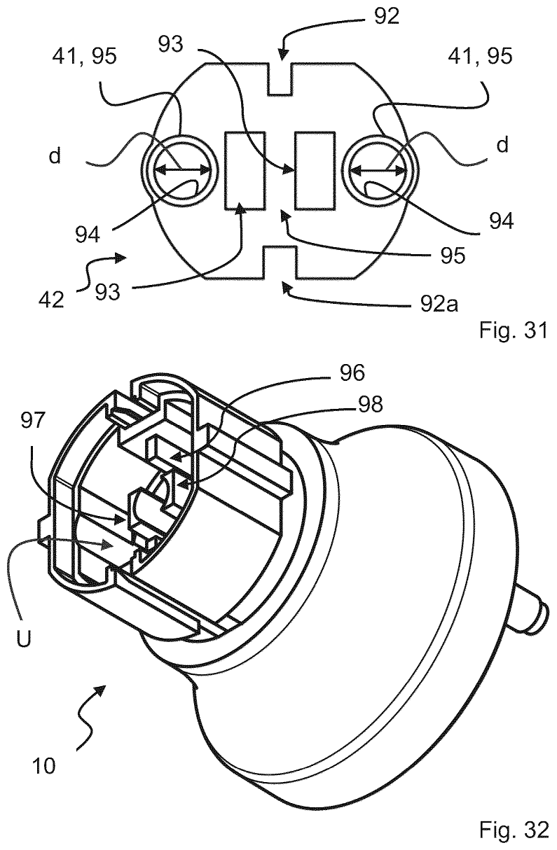

FIG. 31: the exemplary embodiment of FIG. 29 in a view opposite to an insertion direction,

FIG. 32: a further exemplary embodiment of a partial housing of the network plug in a schematic perspectival view,

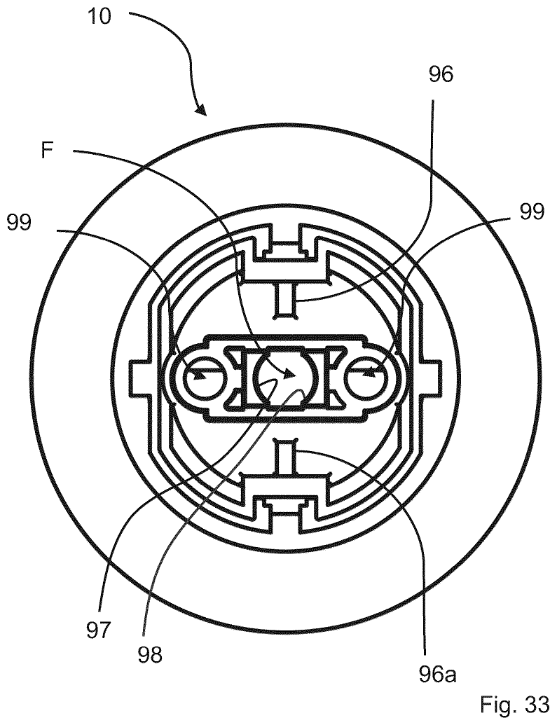

FIG. 33: the exemplary embodiment of FIG. 32 with the protective sleeve device shown in FIGS. 29 to 31 in a frontal view,

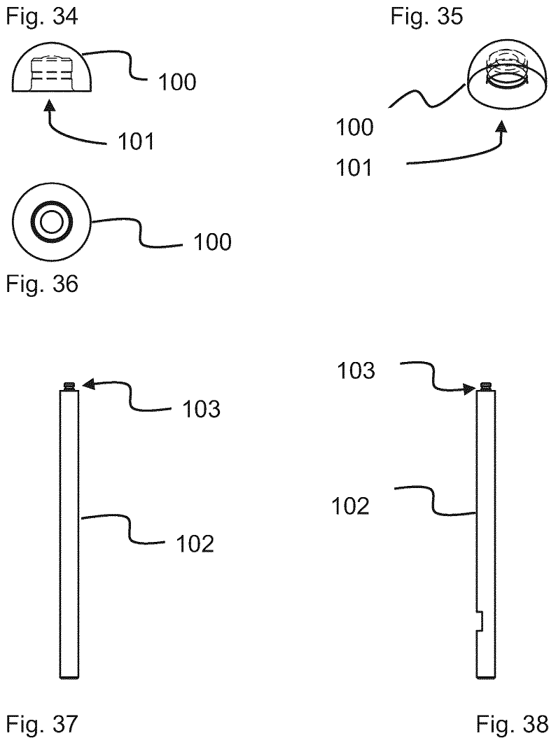

FIG. 34: an exemplary embodiment of a pin head for a free end of a plug contact of the network plug in a side view,

FIG. 35: the exemplary embodiment of FIG. 34 in a perspectival view,

FIG. 36: the exemplary embodiment of FIG. 34 in a view in an insertion direction,

FIG. 37: an exemplary embodiment of a plug contact of the network plug, the free end of which is designed for connection with the pin head, in a first side view,

FIG. 38: the exemplary embodiment of FIG. 37 in a further side view,

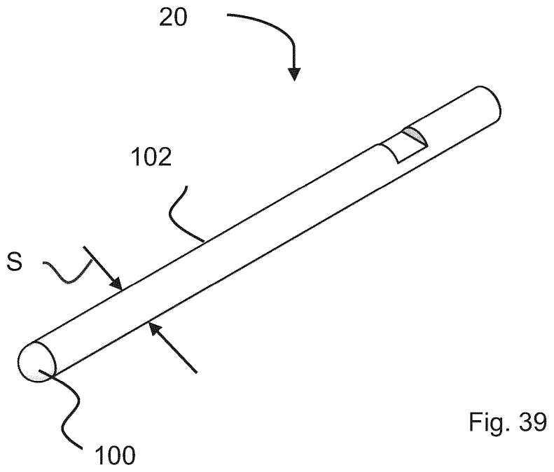

FIG. 39: a perspectival view of the exemplary embodiment of the plug contact of FIG. 37, which is provided with the pin head of FIG. 34,

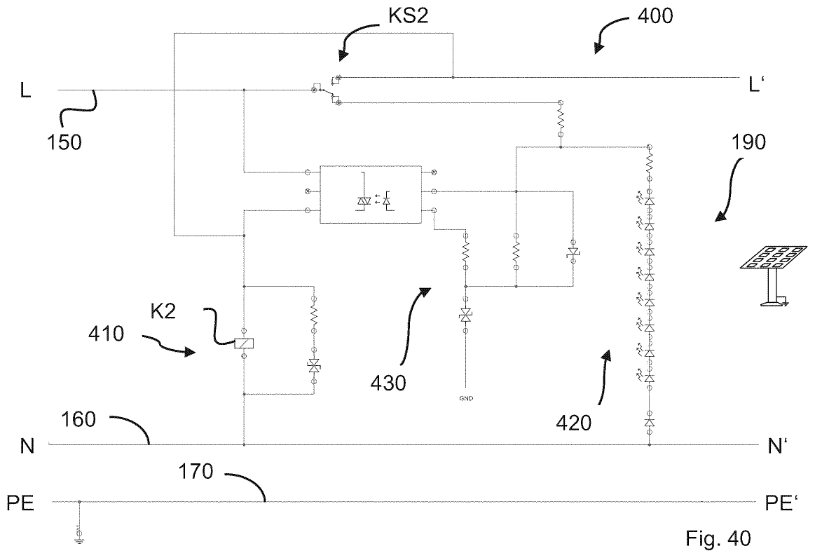

FIG. 40: a further exemplary embodiment of the network connection circuit, and

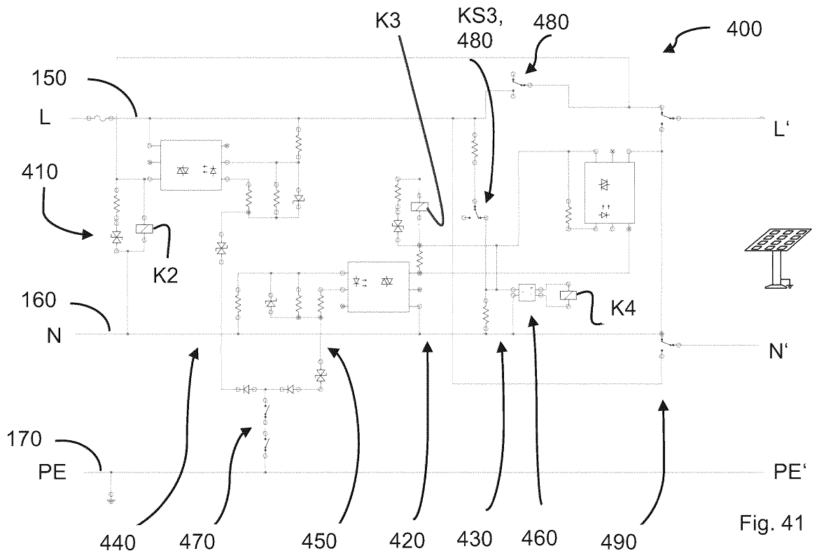

FIG. 41: a further exemplary embodiment of the network connection circuit.

All the depicted network plugs 1 have in common that they have several and in particular at least two plug contacts 20 which are held in a main body 11 or pass through a main body 11. Furthermore, they each have a housing 10 for cladding.

The plug contacts 20 extend along their respective longitudinal directions 21 parallel to each other and accordingly each form a shaft 22. This shaft 22 is fixed on one side with a fastening end region in or on the main body 11, so that each shaft 22 has a free end region 24 for insertion into a receptacle of a socket outlet.

The network plug 1 shown in the figures has different embodiments with regard to its protective device 30.

The network plug 1 shown in FIGS. 1 to 4 includes a protective device 30, which is designed as a spring-mounted protective sleeve device 40. This protective sleeve device 40 comprises, for each plug contact 20, which are only indicated in FIG. 1, substantially hollow-cylindrical protective sleeves 41 as protective elements 31.

It is evident that, in the normal state, the protective sleeves 41 cover the shafts 22 of the plug contacts 20. In this way, the protective sleeves insulate the shafts 22 of the plug contacts 20.

FIG. 3 shows that, on that side of the main body 11 facing away from the protective sleeves 41, there is a base element 42 which connects the protective sleeves penetrating the main body 11.

FIG. 5 shows the protective sleeve device 40 in its entirety in a side view. Here, it is clearly visible that the individual protective sleeves 41 are firmly connected to each other by means of the base element 42. FIG. 6 shows this in a frontal view.

FIG. 7 shows in a frontal view that the protective sleeves 41 penetrate the main body 11 through corresponding bores or openings formed there.

FIG. 8 shows the main body 11 in a perspectival view, wherein a receiving space 12 for receiving the protective sleeve device 40 which is displaceable in the main body 11 is visible.

FIG. 9 shows the network plug without housing, from the side. The protective contacts 26 of the network plug are clearly visible here. Furthermore, a spring assembly 90 in the form of a compression spring can be seen here, which in the embodiment shown here sits on the shaft 24 of a plug contact 20. Against a spring force of this spring assembly 90, the protective sleeve device 40 shown in FIG. 5 can be moved in the direction of the fastening end region 23 of the plug contact 20. In this process, the plug contact 20 or its shaft 22 is exposed and can be electrically contacted.

The force required for this can be applied, for example, by a receptacle of a socket outlet when inserting the network plug 1 into the socket outlet.

If this force no longer exists, the spring assembly 90 causes an opposite displacement of the protective sleeve device 40, so that it again covers the shafts 22 of the plug contacts 20, as shown in FIG. 1.

In the first embodiment of the network plug 1 shown in FIGS. 1 to 9, the spring assembly 90 is not limited to being guided on a plug contact 20, but the spring assembly 90 can also be arranged and guided on an extra guide element instead of being guided on a plug contact 20.

A second embodiment of the network plug and its individual parts is shown in FIGS. 10 to 13. Protective elements 31 of the protective device 30 are compressible protective bodies 50 that surround a respective plug contact 20 or its shaft and thus electrically insulate it.

Such a protective body 50 can, for example, be made of a foam material. An end region 51, spaced apart from the main body 11, of a respective protective body 50 rests against a pressure plate 53. This pressure plate 53 is held by means of a guide device 60 and guided in a base element 42. For this purpose, guide elements 61 run parallel to the longitudinal direction of the protective bodies 50 or also the plug contacts 20, which are displaceably mounted in the base element 42.

When the network plug 1 is inserted into a socket outlet, a force acts from the socket outlet upon the pressure plate 53, which causes the pressure plate 53 to be displaced together with the guide elements 61 arranged on it in the direction of the main body 11. The protective bodies 50 are compressed along this direction. The volume of the protective bodies 50 can be absorbed at least partially in the receiving space 12 of the main body 11 during compression. The elastic restoring forces of the protective bodies 50 are so low, preferably less than 150 N and advantageously less than 80 N, that these elastic restoring forces are not sufficient to automatically eject the network plug from the socket outlet and/or to prevent it from being pushed out on its own.

By inserting the network plug 1 into a socket outlet, the shafts 22 of the plug contacts 20 can be exposed and electrically contacted with a respective socket outlet.

When the network plug 1 is pulled out of the socket outlet, an elastic restoring force 52 of the respective protective body 50 along the longitudinal direction 21 causes a decompression of the protective body 50 and consequently the displacement of the end regions 51 of the protective bodies 50 and consequently also of the pressure plate 53, so that the shafts 22 of the plug contacts 20 are again covered in an electrically insulating manner.

FIGS. 14 to 21 refer to a third embodiment of the network plug 1. In this network plug 1, the plug contacts 20 are movable in relation to the housing 10 along the longitudinal direction 21 of the plug contacts 20. FIGS. 14 and 15 show a situation in which the plug contacts 20 protrude from the housing 10, and FIGS. 16 and 17 show a situation in which the plug contacts 20 are contained in the housing 10 and therefore do not protrude.

When the network plug 1 is not plugged into a socket outlet, it is positioned with the plug contacts retracted, as shown in FIGS. 16 and 17.

The network plug 1 can include a blocking device 80 with a movable actuating element 81, which is movable from a protective contact 26 of a socket outlet when the network plug 1 is inserted into the socket outlet. The mechanical connection between the protective contact 26 and the actuating element 81 is not shown here for the sake of clarity.

When the network plug 1 is inserted into a socket outlet, the protective contact 26 is subjected to a radially acting force and moved slightly radially inwards. This movement of the protective contact 26 is transferred to the movable actuating element 81. This eliminates a blocking effect on the part of the blocking device 80, so that a relative movement 110 can take place between the housing and the plug contacts 20. Accordingly, the plug contacts 20 can now be extended, as shown in FIG. 18. The plug contacts 20 extend out of a front panel 82. After this movement has been carried out, the shafts 22 of the plug contacts 20 are no longer covered by the housing 10 and can be electrically contacted by receptacles of a socket outlet.

The extension of the plug contacts 20 can be achieved by applying a manual actuating force to a drive element not shown here.

When the plug contacts 20 are inserted into receptacles of the socket outlet, the frictional forces occurring between the receptacle and a respective plug contact 20 can hold the plug contact 20 in the extended position.

When the network plug 1 is pulled out of the socket outlet, these frictional forces no longer exist. A spring assembly 90, supported on the front panel 82 on one side and on the main body 11 on the other, exerts a spring force 91 directly or indirectly on the plug contacts 20, so that, in the relative movement 110, these are retracted back into the housing, so that the shafts 22 of the plug contacts 20 no longer protrude from the housing or from the front panel 82.

This ensures that no unintentional electrical contact can occur between the plug contacts 20 when the network plug 1 is not in use.

FIG. 22 shows an exemplary circuit diagram of an electrical network connection circuit for the network plug or device. This electrical network connection circuit includes a first switching element, exemplified as relay K1, to which a first switch, e.g., a relay switch KS1, is assigned. As an alternative to designing the first switching element as a relay with a relay switch, the first switching element can also be designed, for example, as a semiconductor switching element, such as a triac, with a semiconductor switch. Furthermore, the circuit includes a second switching element, exemplified as relay K2, to which a second switch, e.g., a relay switch KS2, is assigned. As an alternative to designing the second switching element as a relay with a relay switch, the second switching element can also be designed, for example, as a semiconductor switching element, such as a triac, with a semiconductor switch.

The first switching element is located in a third current path 140 between a live phase 150 and an optional protective conductor 170. The second switching element is located between the live phase 150 and a neutral conductor 160. If the network plug 1 has a protective conductor 170, the network plug 1 can be a protective contact plug.

The live phase 150 can also be referred to as the outside conductor.

If the current path between the live phase 150 and the first switching element is closed, the first switching element is energized and closes the current path to the second switching element via the first switch, so that the latter is energized. This opens the current path via the second switch to the first switching element, thereby closing a circuit.

If the current path between the live phase 150 and the first switching element is not closed, there is also no current flow from the live phase 150 to the first switching element. This means it is not activated, so it does not close a current path to the second switching element, and the second switching element is not energized. Accordingly, the second switching element does not open the current path via the second switch to the first switching element and does not close a circuit.

In a first current path 120 between the live phase 150 of the network plug and the neutral conductor 160 of the network plug, a first contact KS21 of the second switch and a first signaling device 180 are arranged in series.

This first signaling device 180 can be a lighting element, such as a red lamp. If the live phase 150 is not properly contacted, a signal is output by the first signaling device indicating that no proper contact has been made.

In a second current path 130 between the live phase 150 and the neutral conductor 160, a second contact KS22 of the second switch and a second signaling device 190 are arranged in series. The second signaling device 190 can be a lighting element, such as a green lamp.

If correct contact is established, the second signaling device will output a corresponding signal.

In addition, a hand switch 200 is arranged in series with the second signaling device 190, which hand switch is designed, for example, as a normally closed switch, so that the signal output via the second signaling device 190 occurs only when the hand switch 200 has been closed. The hand switch 200 can be a mechanically actuated switch, a capacitively actuated switch, or an otherwise actuated switch.

FIG. 23 shows a further exemplary embodiment of the network connection circuit. For elements that correspond in function and/or design to elements of the exemplary embodiment shown in FIG. 22, the same reference signs are used for brevity. The following discussion focuses solely on the differences compared to the exemplary embodiment shown in FIG. 23.

In the exemplary embodiment shown in FIG. 23, the relay K1 with the relay switch KS1 is replaced by a triac. Optionally, an RC circuit, which can also be called a snubber, is connected in parallel to the triac.

FIG. 24 shows a further exemplary embodiment of the network connection circuit. For elements that correspond in function and/or design to elements of the exemplary embodiment shown in FIG. 23, the same reference signs are used for brevity. The following discussion focuses solely on the differences compared to the exemplary embodiment shown in FIG. 24.

The network connection circuit of FIG. 24 additionally features an ohmic resistor R1 directly connected in front of the triac input.

FIG. 25 shows a further exemplary embodiment of the network connection circuit. For elements that correspond in function and/or design to elements of the exemplary embodiment shown in FIG. 24, the same reference signs are used for brevity. The following discussion will focus solely on the differences compared to the exemplary embodiment shown in FIG. 25.

The network connection circuit of FIG. 25 is designed not only to recognize but also to correct a polarity error. For this purpose, the network connection circuit also features another switch KS3 with a triac and an optional RC circuit, which can be described as a snubber. A resistor R3 is connected directly in front of the triac at the input. Furthermore, the network connection circuit has another switch in the form of a triac, which is connected in parallel to the triac of switch KS1 and to which a resistor R2 is directly connected on the input side.

FIG. 26 shows an exemplary embodiment of a network connection device. A converter Q is connected downstream of a source G, e.g., a direct current source, such as a photovoltaic system or a wind turbine. The converter Q can be connected or connectable to a battery storage device or other energy storage device capable of storing direct current. Furthermore, FIG. 26 shows an arc fault protection device 300 and, connected downstream of the arc fault protection device 300, a reverse polarity protective circuit 400, which can optionally both be housed in a common housing of the network connection device. The reverse polarity protective circuit 400 can be an integral part of the network plug 1. The reverse polarity protective circuit 400 can have or be one of the circuits of the exemplary embodiments shown in FIGS. 22 to 25. The housing with the arc fault protection device 300 and the network plug 1 can be designed and/or provided separately from the converter Q and can optionally be electrically conductively connected to it by means of a plug connection. Furthermore, the protective devices 400 and 300 could also be implemented in one housing.

FIG. 27 shows a further exemplary embodiment of the network connection device of FIG. 26, in which the protective devices for the network plug are implemented in different housings. For elements that correspond in function and/or design to elements of the exemplary embodiment shown in FIG. 26, the same reference signs are used for brevity. The following discussion will focus solely on the differences compared to the exemplary embodiment shown in FIG. 26.

In the exemplary embodiment of FIG. 27, the arc fault protection device 300 and the reverse polarity protective circuit 400 are integrally formed together and are arranged, for example, in a common sub-housing, which can optionally be housed in the housing of the network connection device which also has the network plug 1.

FIG. 28 shows an exemplary embodiment of a network connection module which has a housing into which the converter Q and the arc fault protection device 300 are integrated.

FIG. 29 shows a further exemplary embodiment of the protective device 30 schematically with the base element 42, from which two protective sleeves 41 project in an insertion direction.

The base element 42 can have a canting element 92. For example, the canting element 92 is a recess in the base element 42 or a groove that extends completely through the base element 42 in the insertion direction of the plug. The canting element 92 can have an open end that points transversely to the insertion direction. The canting element 92 can be arranged on an edge of the base element 42. The edge can circumferentially surround the base element 42 transversely to the insertion direction, thus extending around the base element 42 in a circumferential direction pointing around the insertion direction.

The base element 42 can have at least one receiving opening 93 and, for example, two receiving openings 93 for receiving a spring guide. The at least one receiving opening 93 can extend completely through the base element 42 in the insertion direction. The at least one receiving opening 93 can be completely surrounded by the material of the base element 42 transversely to the insertion direction. The at least one receiving opening 93 can be arranged between the protective elements 41. If several, e.g., two, receiving openings 93 are provided, these can be arranged one behind the other in a direction transverse to the insertion direction and in which the protective elements 41 are spaced apart from each other.

FIG. 30 shows the exemplary embodiment of FIG. 29 schematically in a side view, in which the insertion direction can run parallel to the drawing plane.

As an alternative to designing the protective elements 41 as hollow cylinders, at least one of the protective elements 41 can, as already shown in the exemplary embodiments of FIGS. 1 to 6, have a receiving volume V for one of the plug contacts, the diameter D of which runs transversely to the insertion direction and can decrease in the direction toward the free ends of the protective elements 41. The receiving volume V can, for example, be cone-shaped. A minimum diameter of the receiving volume V can substantially correspond to an outer diameter of one of the plug contacts. Tilting the protective device 30 can also cause at least one of the protective elements 41 to jam against one of the plug contacts, resulting in self-locking.

The inner diameter of at least one of the protective elements 41, which may correspond to the diameter D, can be minimal at the free end of the protective elements 41 and substantially correspond to the outer diameter of one of the plug contacts. This prevents even small or thin conductors, such as a wire, from simply being inserted into one of the protective elements at the insulated end of one of the plug contacts.

The receiving volume V can be limited by an inner surface 94 of the at least one protective element 41, such that the inner surface 94 can be shaped in a complementary manner to the possibly conical receiving volume V.

An angle W between the inner side 94 and the base element 42, and in particular between the inner side 94 and a front face of the base element 42 from which the at least one protective element 41 projects, can be less than 90°. For example, the angle W can be up to 80°, 85°, or 89°. The inner side 94 of the protective element 41 can be aligned at an angle to the insertion direction which is not equal to zero and can, for example, be up to 10°, 5°, or 1°.

The at least one protective element 41 can have a constant wall thickness, so that an outer side 95 of the at least one protective element 41 can run parallel to the inner side 94. Alternatively, the wind force of at least one protective element 41 can change in the insertion direction, i.e., away from the base element 42, and may, for example, increase. For example, at least one protective element 41 can have a cylindrical outer shape instead of a conical outer shape.

FIG. 31 shows the exemplary embodiment of FIGS. 29 and 30 in a frontal view, in which the protective elements 41 point out of the plane of the drawing parallel to the insertion direction.

In addition to the canting element 92, the base element 42 may have an optional canting element 92a. The canting element 92 and the optional canting element 92a can be arranged symmetrically to each other and, for example, on opposite sides of the base element 42. The canting element 92 and the optional canting element 92a can be identically designed. Alternatively, the optional canting element 92a can be shaped differently and, for example, can be wider and/or deeper than the canting element 92. A rotation protection that can be provided by the different design of the canting element 92 and the optional canting element 92 can also be provided by only the one canting element 92 being provided.

The base element 42 can have a support bridge 95 remaining between the receiving openings 93, which support bridge can serve as a support for a spring assembly.

FIG. 32 schematically shows an exemplary embodiment of the housing 10 of the network plug in a perspectival view. In the illustrated exemplary embodiment, the housing 10 has a contact receiving volume U, which is designed to receive the plug contacts 20 and the protective device 30.

The housing 10 of the network plug can have at least one counter-canting element 96 designed to interact with the counter-canting element 92 of the protective device. The canting element 92 can be designed to be complementary to the counter-canting element 96.

The counter-canting element 96 can be designed as a web or as a projection that can engage, for example, as a groove or the recess of the canting element 92. The counter-canting element 96 can extend along the insertion direction and have a free end pointing transversely to the insertion direction—for example, into the interior of the plug housing 10. The entire counter-canting element 96 can run parallel to the insertion direction.

A clear width of the at least one canting element 92 and a width of the counter-canting element 96 parallel to the clear width can be dimensioned such that the base element 42 with the canting element 92 can slide on the counter-canting element 96 when the base element 42 is pushed further into the plug housing 10 against the insertion direction. For example, the clear width and the width are the same.

If the base element 42 is pushed further into the connector housing 10 against the insertion direction, the canting element 92 can slide on the counter-canting element 96. However, if a force acts upon the base element 42, wherein the force acts at an angle to the insertion direction that is not equal to 0° or not equal to 180°, this force can tilt the base element 42. This tilting action allows the canting element 92 and the counter-canting element 96 to cant with each other, so that the force does not cause any further movement of the base element 42 against the direction of insertion into the plug housing 10, and the plug contacts 20 remain in the protective device 40 and cannot protrude from it in a non-contactable manner.

The housing 10 of the network plug can have a spring guide arranged in the contact receiving volume U. The spring guide of the housing 10 can be designed as a pin extending in the insertion direction, onto which a spring assembly 90, e.g., a coil spring, can be mounted. In this case, it may be sufficient if the base element 42 has only one receiving opening 93. The diameter of the receiving opening 93 can be smaller than the diameter of the spring assembly 90, so that the material of the base element 42, which at least partially surrounds the receiving opening 93, can serve as a support or stop or abutment for the spring assembly 90. The diameter of the receiving opening 93 can substantially correspond to the diameter of the pin, so that the base element 42 with the receiving opening 93 can slide on the pin and possibly even cant if a force attempts to move the base element 42 non-parallel to the insertion direction.

The spring guide of the housing 10 can have at least two guide beams 97, 98 running parallel to the insertion direction, the sides of which facing each other can be substantially complementary to the spring assembly 90—for example, a coil spring. The guide beams 97, 98 can be arranged opposite each other and/or spaced apart from each other, transversely to the insertion direction.

The base element 42 can have one of the receiving openings 93 for each of the guide beams 97, 98. At least one of the receiving openings 93 can be designed to be complementary to the guide beam 97, 98 which it receives, so that the base element 42 with the receiving opening 93 can slide on the guide beam 97, 98 and possibly even cant if a force attempts to move the base element 42 non-parallel to the insertion direction.

FIG. 33 shows the exemplary embodiment of FIG. 32 schematically in a frontal view, in which a plug face of the housing 10, which is not yet provided with the plug contacts 20 and the base element 42, points out of the plane of the drawing in the insertion direction.

In addition to the counter-canting element 96, the base element 42 may have an optional counter-canting element 96a. The counter-canting element 96 and the optional counter-canting element 96a can be arranged symmetrically to each other and, for example, on opposing inner sides of the housing 10. The counter-canting element 96 and the optional counter-canting element 96a can be identically designed. Alternatively, the optional counter-canting element 96a can be shaped differently and, for example, can be wider and/or deeper than the counter-canting element 96. A rotation protection that can be provided by the different design of the counter-canting element 96, and the optional counter-canting element 9a can also be provided by only the one counter-canting element 96 being provided.

The guide beams 97, 98 jointly flank a spring receptacle F, into which the spring assembly 90, e.g., a coil spring or at least a disc spring, can be inserted. The guide beams 97, 98 can guide the spring assembly 90 along the insertion direction in such a way that unwanted movements of the spring assembly 90 transverse to the insertion direction are prevented by the guide beams 97, 98. Contact vias 99 of the housing 10 for the plug contacts 20 can flank the spring receptacle F and/or the guide beams 97, 98. The contact vias 99, the spring receptacle F, and/or the guide strips 97, 98 can be arranged one behind the other along a direction transverse to the insertion direction.

FIGS. 34 to 36 show schematic views of an electrically insulating pin head 100, which may be made, for example, of an electrically insulating plastic and/or of rubber. The pin head 100 can have a mounting opening 101 with an open end. Opposite the open end, the pin head 100 can have a closed end. An outer side, having the closed end and pointing away from the mounting opening 101, of the pin head 100, can be at least partially curved and, for example, can be hemispherical, angled, conical, or tapered.

Between the open end and the closed end of the mounting opening 101, the mounting opening 101 can have a locking element—for example, a tapering running parallel to the open end.

The pin head 100 can also be referred to as a plug contact cap.

FIGS. 37 and 38 show an exemplary embodiment of a contact pin 102, which can provide one of the plug contacts 20 with the pin head 100. A free end of the contact pin 102 can have a mounting element 103 for mounting the pin head. The mounting element 103 can be designed to be complementary to the mounting opening 101 at least in portions and can have a counter-locking element for the locking element—for example, a projection that circumferentially surrounds the mounting element 1030 at least in portions transversely to the longitudinal direction of the contact pin 102.

FIG. 39 shows the plug contact 20 with the pin head 100 of FIGS. 34 to 36 in a state mounted on the contact pin 102, in which state the mounting element 103 is inserted into the mounting opening 101. A diameter S of the substantially cylindrical contact pin 102 corresponds to the diameter of the pin head on its side facing the contact pin 102. The open end of the mounting opening 101 can be arranged on the side facing the contact pin 102. The side facing the contact pin 102 can be referred to as the base of the pin head 100. Away from the side facing the contact pin 102, the diameter of the pin head 100 can decrease.

FIG. 40 shows a further exemplary embodiment of the network connection circuit. For elements that correspond in function and/or design to elements of the exemplary embodiment shown in FIG. 23, the same reference signs are used for brevity. The following discussion focuses solely on the differences compared to the exemplary embodiment shown in FIG. 24.

FIG. 40 shows, by way of example, another circuit diagram of an electrical reverse polarity protective circuit 400 according to the invention—for example, for a network plug 1. The reverse polarity protective circuit 400, which can also be called a network connection circuit, has three contacts L, N, PE for the input and three contacts L′, N′, PE′ for the output. The network plug 1 is correctly inserted when the live phase of a mating connector, such as a network socket outlet, is connected to conductor 150 of the reverse polarity protective circuit 400. The respective phases at the input and at the output are then the same. A signaling device 190, such as an array of photodiodes, lights up and indicates the correct contact state. If the network plug is inserted incorrectly into the mating connector, the signaling device 190 may not light up or may light up differently, and no live phase is transferred from the input contact conductor L to the output contact L′, thus interrupting the current flow. For example, an inverter of a DC voltage source, such as a photovoltaic system or another energy supply system, can be connected to or become connected to the L′, N′, PE′ contacts of the output. The nest plug can be connected to the L, N, and PE contacts of the input.

Specifically, the circuit diagram shown as an example in FIG. 40 has three circuits 410, 420, 430. Two of the circuits 410, 420 connect the live conductor 150 and the neutral conductor 160. A third circuit 430 connects the live conductor 150 to the protective conductor 170.

The second circuit 420 can include a two-way switch, such as the relay KS2, several resistors, the signaling device 190, and a diode connected in series with the signaling device 190, wherein the signaling device 190 can have photodiodes connected in series with each other. Once the live phase of the network voltage is correctly applied, the signaling device 190 can signal that the network plug 1 is correctly inserted.

The first circuit 410 can connect the live conductor 150 to the neutral conductor 160 via a diac of an optocoupler and via a switch, such as an electronic switch or a switch with an electromechanical drive, such as the relay K2. The electromechanical drive can be protected from voltage pulses or short-term voltage pulses by a suppressor diode and a resistor in a parallel circuit.

The third circuit 430 can connect the live conductor 150 to the protective conductor 170 via the two-way switch, via a photodiode of the optocoupler, via several resistors and suppressor diodes.

If the network plug 1 is correctly inserted so that it connects the live phase of the schematically depicted device for generating electrical energy to the live phase of the network, the third circuit 430 and the second circuit 420 can be switched to a live state. In addition to the LED's of the signaling device 190, the photodiode in the optocoupler can also light up. The light emitted by the photodiode is received by the diac of the optocoupler. The diac of the optocoupler can then switch the first circuit 410 to a live state.

When the optocoupler's diac receives a signal, current can flow through the electromechanical drive that controls the two-way switch. When current flows through the electromechanical drive, the two-way switch can be switched such that the input L is coupled to the output L′, and the input L and the output L′ have the same phase. As soon as the electromechanical drive switches the two-way switch, the current flow through the second circuit 420 and through the third circuit 430 can be stopped. Thus, the signal device 190 can be deactivated.

FIG. 41 shows, by way of example, another circuit diagram of an electrical reverse polarity protective circuit 400 according to the invention—for example, for a network plug 1. The circuit of FIG. 41 is designed to adapt the phase position of the voltage applied to the network plug 1 to the phase position of the network socket outlet and to switch it as required.

The reverse polarity protective circuit 400 shown in FIG. 41 has three contacts L, N, PE for the input and three contacts L′, N′, PE′ for the output. In contrast to the circuit diagram in FIG. 40, the circuit diagram in FIG. 41 does not have an array of photodiodes. In the circuit diagram shown in FIG. 41, instead of signaling an incorrect insertion, the phases incorrectly applied to the input contacts L, N are swapped. The correct phases are then applied to the output contacts L′, N′, thus correcting any incorrect insertion of the network plug 1.

Specifically, the circuit diagram shown in FIG. 41 has five circuits 410, 420, 430, 440, 450. Three of the circuits 410, 420, 430 can connect the conductor for the live phase 150 to the neutral conductor 160. A fourth circuit 440 can connect the conductor 150 to the protective conductor 170. A fifth circuit 450 can connect the conductor 160 to the protective conductor 170.

The first circuit 410 can connect the conductor 150 to the conductor 160 via a first diac of a first optocoupler and via a switch, such as an electronic switch or a switch with electromechanical actuation, such as relay K2. The switch can be protected from voltage pulses or short-term voltage pulses in a parallel circuit by a first suppressor diode and a resistor.

The second circuit 420 can connect the conductor 150 to the conductor 160 via a diac of a second optocoupler and via another switch, such as an electronic switch or a switch with electromechanical drive, such as another relay K3. The second switch can be protected from voltage pulses or short-term voltage pulses in a parallel circuit by a second suppressor diode and a second resistor.

The third circuit 430 can connect the conductor 150 to the neutral conductor 160 via a switch KS3, several resistors, and an initialization unit 460 to check whether a network voltage is present, wherein the initialization unit 460 is coupled to yet another switch, such as an electronic switch or a switch with electromechanical drive, such as another relay K4.

The fourth circuit 440 can connect the conductor 150 to the protective conductor 170 via a first photodiode of the first optocoupler, via several suppressor diodes, resistors, and a diode, as well as via further coupled switches 470. The further coupled switches 470 can be switched by the further switch, such as an electronic switch or a switch with electromechanical drive, such as another relay K4, which in turn is part of the third circuit 430.

The fifth circuit 450 can connect the conductor 160 to the protective conductor 170 via a photodiode of the second optocoupler, several suppressor diodes, resistors, and a diode, as well as via the coupled switches 470. The coupled switches 470 can therefore switch the fourth circuit 440 and the fifth circuit 450 to a live state.

When the network plug 1 is inserted into the network socket outlet, the third circuit 430 can be switched to a live state, regardless of whether the live phase 150 of the network voltage is applied to input L or N. As soon as network voltage is applied at the input, the third electromechanical drive, for example, can be switched on. The third electromechanical drive can switch the coupled switches 470, which switch the fourth circuit 440 and the fifth circuit 450 to a live state. As soon as the third electromechanical drive switches, the fourth circuit 440 and the fifth circuit 450 can be switched to a live state, so that either the photodiode of the first optocoupler or the photodiode of the second optocoupler is switched to a live state or is activated. Which photodiode is activated depends upon which conductor is the live phase.

If the live phase of the network voltage is connected to the conductor 150, then, in addition to the third circuit 430, the fourth circuit 440 can also be or become switched to a live state. The current flow in the fourth circuit 440 causes light to be emitted from the photodiode of the first optocoupler, which is received by the diac of the first optocoupler. The diac of the first optocoupler can thus switch the first circuit 410 to a live state, so that, for example, the first electromechanical drive is switched. The first electromechanical drive, in turn, can actuate two first two-way switches 480 in such a way that the live phase is transferred from the input conductor L to the output conductor L′. Furthermore, the connection between the conductor 150 and the conductor 160 via the third circuit 430 can be interrupted by the first electromechanical drive. The phases of the input contacts and the output contacts are therefore the same.

If the live phase of the network voltage is now applied to the conductor 160, the fourth circuit 440 may be switched to a live state, but there is no significant current flow between the normal conductor 150 and the protective conductor 170. Thus, the photodiode of the first optocoupler does not emit light, so no light is received by the diac in the first optocoupler, which in turn results in the first circuit 410 not being switched to a live state. Therefore, the first electromechanical drive also does not switch the two first two-way switches 480 mentioned above.

If the live phase of the network voltage is applied to the conductor 160, then the fifth circuit 450 can be switched to a live state. In this case, light is emitted by the photodiode of the second optocoupler and received by the diac of the second optocoupler. This causes the diac of the second optocoupler to switch the second circuit 420 to a live state. As soon as the second circuit 420 is switched to a live state, the exemplary second electromechanical drive also switches. This in turn results in the second coupled two-way switches 490 being switched. When the second coupled two-way switches 490 are switched, the live phase of the network voltage of the input contact N is transferred to the output contact L′. In addition, the input contact L is connected to the output contact N′ by switching the second coupled two-way switches 490. The phases present at the input are therefore reversed at the output. One advantage of this design in FIG. 41 can be that, in operation, the reference contact, here 170, is galvanically isolated from the rest of the electronics via a separation point (normally open contacts of K4).

### LIST OF REFERENCE SIGNS

1 network plug
10 housing
11 main body
12 receiving space
20 plug contact
21 longitudinal direction
22 shaft
23 fastening end region
24 free end region
26 protective contact
30 protective device
31 protective element
40 protective sleeve device
41 protective sleeve
42 base element
50 protective body
51 end region
52 elastic restoring force
53 pressure plate
60 guide device
61 guide element
80 blocking device
81 movable actuating element
82 front panel
90 spring assembly
91 spring force
92 canting element
92a optional canting element
93 receiving opening
94 inner side
95 support bridge
96 counter-canting element
97 guide beam
98 guide beam
99 contact vias
100 pin head
101 mounting opening
102 contact pin
103 mounting element
110 relative movement
120 first current path
130 second current path
140 third current path
150 live phase
160 neutral conductor
170 protective conductor
180 first signaling device
190 second signaling device
200 hand switch
300 arc fault protective device
400 reverse polarity protective circuit
410 circuit
420 circuit
430 circuit
440 circuit
450 circuit
460 initial unit
470 coupled switch
480 first coupled two-way switch
490 second coupled two-way switch
D diameter
d minimum diameter
F spring receptacle
G source
K1 first relay
KS1 first relay switch
K2 second relay
KS2 second relay switch
KS21 first contact of the second relay switch
KS22 second contact of the second relay switch
K3 further relay
KS3 switch
K4 further relay
L input contact
L′ output contact
N input contact
N′ output contact
PE input contact
PE′ output contact
Q converter
R1 resistor
R2 resistor
R3 resistor
S diameter contact pin
U contact receiving volume
V receiving volume
W angle

1. A network connection circuit with reverse polarity protection, for connecting a device for generating electrical energy to an AC voltage network having a protective conductor, a neutral conductor, and an, in operation, outside conductor, with a first connection line and a second connection line, wherein
the first connection line is intended for connection to the neutral conductor and the second connection line is intended for connection to the outside conductor,
and wherein the network connection circuit has a phase position recognition device,
which is electrically connected to the first and second connection lines and is designed to determine a phase position between the second connection line and the first connection line, and
which is designed to provide an operating signal when the phase position corresponds to a predetermined phase position, and to output an error signal when the phase position deviates from the predetermined phase position.

2. The network connection circuit according to claim 1, characterized in that the network connection circuit has a switching element which, in the closed state, connects two portions of the second connection line when the phase position recognition device provides the operating signal.

3. The network connection circuit according to claim 1, characterized in that the network connection circuit has a switching element configured to connect two portions of the first connection line together and to connect two portions of the second connection line together when the phase position recognition device provides the operating signal, and configured to connect a portion of the first connection line to a portion of the second connection line, and to connect another portion of the first connection line to another portion of the second connection line when the phase position recognition device does not provide the operating signal.

4. The network plug (1) for realizing an electrical plug contact, with two plug contacts (20) for making a plug connection to a mating connector and with a protective contact, and with at least three connection contacts for connecting conductors of a connection cable to each of the plug contacts, characterized in that the plug contacts and the protective contact are connected to the connection contacts with a reverse polarity protective circuit according to claim 1.

5. The device for generating electrical energy, with an energy output having at least three electrical contacts for providing the generated electrical energy, characterized in that a reverse polarity protective circuit according to claim 1 is connected upstream of the energy output.

6. A method for connecting a device for generating electrical energy to an AC voltage network (low-voltage network) having a protective conductor, a neutral conductor, and an outside conductor, in which, after a mechanical contact of an energy output of the device to the AC voltage network by means of a network plug, the polarity of energy lines of the device leading to the energy output is first compared with the polarity of the lines of the AC voltage network, and the device is connected to the AC voltage network depending upon the result of the comparison.

7. The method according to claim 6, characterized in that a connection between an outside conductor of the device and an outside conductor of the AC voltage network is only closed if the comparison shows that the power lines are connected with the same polarity to the lines of the AC voltage network via the network plug.

8. The method according to claim 6, characterized in that a connection between an outside conductor of the device and an outside conductor of the AC voltage network is first switched crosswise and then closed if the comparison shows that the power lines are connected with non-uniform polarity to the lines of the AC voltage network via the network plug.

9. A network plug for realizing an electrical plug contact, comprising at least two elongated plug contacts, each having a shaft for electrical contact, a fastening end region, and a free end region, and comprising at least one protective device with which at least the shafts of the plug contacts are protected or can be protected against unintentional electrical contact, wherein a relative movement is possible between at least one region of the protective device and the plug contacts, so that the shafts of the plug contacts can at least partially be exposed and electrically contacted.

10. The network plug according to claim 9, characterized in that the protective device for covering the shafts of the plug contacts comprises a spring-mounted protective sleeve device, which has a protective sleeve for each plug contact as a protective element, wherein the protective sleeve device may further have a base element, and the protective sleeves may be rigidly mechanically coupled to each other by means of the base element, so that they are together displaceable on the shafts of the plug contacts.

11. The network plug according to claim 10, characterized in that the network plug can have a guide device for guiding the protective device along the longitudinal direction of the plug contacts, wherein the guide device may counteract uneven displacement of the protective elements on the plug contacts by canting the base element on a guide element of the guide device.

12. The network plug according to claim 11, characterized in that the guide device is arranged between the plug contacts.

13. The network plug according to claim 11, characterized in that the base element has a canting element, and a housing of the network plug has a counter-canting element designed to be complementary to the canting element and designed to interact with the canting element.

14. The network plug according to claim 13, characterized in that the canting element and the counter-canting element are designed such that the canting element slides on the counter-canting element when the base element is pushed further into a housing of the network plug along an insertion direction, wherein the canting element and the counter-canting element cant with each other when a force acting upon the base element, which acts at an angle to the insertion direction that is not equal to 0° or not equal to 180°, seeks to press the base element into the housing.

15. The network plug according to claim 9, characterized in that the protective device for covering the shafts of the plug contacts comprises a spring-mounted protective sleeve device, which has a protective element for each plug contact, wherein at least one of the protective elements has a receiving volume for one of the plug contacts, the diameter of which extends transversely to the insertion direction and decreases toward the free ends of the protective elements, and wherein the minimum diameter of the receiving volume corresponds substantially to an outer diameter of one of the plug contacts.
